(19) United States
(12) Patent Application Publication
(10) Pub. No.: US 2013/0187421 A1
(43) Pub. Date: Jul. 25, 2013

(54) SEAT WITH INTEGRATED CHILD RESTRAINT ADJUSTMENT SYSTEM

(71) Applicants: Christopher W. Foye, Indianapolis, IN (US); Chad A. Sparling, Kokomo, IN (US)

(72) Inventors: Christopher W. Foye, Indianapolis, IN (US); Chad A. Sparling, Kokomo, IN (US)

(73) Assignee: INDIANA MILLS AND MANUFACTURING, INC., Westfield, IN (US)

(21) Appl. No.: 13/556,284

(22) Filed: Jul. 24, 2012

Related U.S. Application Data
(60) Provisional application No. 61/511,370, filed on Jul. 25, 2011.

(51) Int. Cl. B60R 22/10

(52) U.S. Cl. CPC B60R 22/105
USPC 297/232

(57) ABSTRACT

A vehicle seat comprises a frame, a primary seat support secured to the frame, a seat back secured to the frame, and a child seat assembly secured to the frame. The child seat assembly comprises at least one panel, a harness, an adjustment assembly, and at least one guard member. The at least one panel is pivotable relative to the frame. The harness is configured to removably secure an occupant of the child seat assembly relative to the frame and includes. The adjustment assembly is configured to provide adjustment of the harness and is positioned above a shoulder portion of the harness. The adjustment assembly comprises a pivoting member operable to selectively restrain movement of at least a portion of the harness. The at least one guard member is configured to deflect hair away from the adjustment assembly during sliding movement of the harness relative to the adjustment assembly.

### PRIORITY

This application claims priority to U.S. Provisional Patent Application Ser. No. 61/511,370, entitled “Integrated Child Restraint Adjust System,” filed Jul. 25, 2011, the disclosure of which is incorporated by reference herein.

### BACKGROUND

In various kinds of vehicles, it may be desirable to provide restraint systems that can be used to secure a passenger to the seat while the vehicle is in motion. Some such systems may provide adjustability to accommodate passengers of various sizes. However, some conventional adjustable restraint systems, particularly those that are already integrated into a vehicle seat, may not be suitable for very small passengers such as small children. It may be preferable in such instances to provide a restraint system that is more specially tailored to accommodate small children. An example of such a system may be found in a child car seat that may be removably secured to a larger seat that is integral with the vehicle. After a small child has been transported in the removable car seat, the removable car seat may be removed in order to enable the integral vehicle seat to again accommodate a larger passenger. In some settings it may be desirable to integrate restraint systems for passengers of sizes ranging from very small children to large adults into a single seat, eliminating the need for an additional removable seat. It may also be desirable to maximize ease of adjustment in such restraint systems without sacrificing safety or integrity of the restraint systems.

Examples of integral restraint systems for various vehicles may be found in the following patent references, the disclosure of each of which is incorporated by reference herein: U.S. Pat. No. 8,061,781, entitled “Configurable Restraint System for a Vehicle Seat,” issued Nov. 22, 2011; U.S. Pat. No. 7,144,085, entitled “Passenger Restraint System,” issued Dec. 5, 2006; U.S. Pat. No. 7,040,696, entitled “System of Seats for a Vehicle,” issued May 9, 2006; U.S. Pat. No. 7,029,067, entitled “Vehicle Seat Including an Integrated Child Seat,” issued Apr. 18, 2006; U.S. Pat. No. 6,886,889, entitled “Restraint System for a Vehicle,” issued May 3, 2005; U.S. Pat. No. 6,508,515, entitled “Restraint System for a School Bus Seat,” issued Jan. 21, 2003; U.S. Pat. No. 6,485,098, entitled “Restraint System for a School Bus Seat,” issued Nov. 26, 2002; U.S. Pat. No. 6,123,388, entitled “Restraint System for a School Bus,” issued Sep. 26, 2000;

While a variety of child restraint devices have been made and used, it is believed that no one prior to the inventor(s) has made or used an invention as described herein.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1 depicts a perspective view of an exemplary bus seat with an integral child seat in an upright unfolded position;

FIG. 2 depicts a perspective view of the bus seat of FIG. 1 with the integral child seat in a folded and deployed position;

FIG. 3 depicts an exploded perspective view of the bus seat of FIG. 1;

FIG. 4 depicts a perspective view of the integral child seat assembly of the bus seat of FIG. 1;

FIG. 5 depicts a perspective view of a sub-assembly of the integral child seat assembly of FIG. 4;

FIG. 6 depicts a bottom plan view of the sub-assembly of FIG. 5;

FIG. 7 depicts a partial, perspective view of an upper region of the sub-assembly of FIG. 5;

FIG. 8 depicts a partial, cross-sectional view of the sub-assembly of FIG. 7, taken along line 8-8 of FIG. 7;

FIG. 9 depicts an enlarged, partial, cross-sectional view of the sub-assembly of FIG. 7, taken along line 8-8 of FIG. 7;

FIG. 10 depicts a perspective view of a base webbing of the sub-assembly of FIG. 7;

FIG. 11 depicts a cross-sectional view of the base webbing of FIG. 10, taken along line 11-11 of FIG. 10;

FIG. 12A depicts a perspective view of the bus seat of FIG. 1 with the integral child seat in a folded and deployed position and the webbing unbuckled to receive a child;

FIG. 12B depicts a perspective view of the bus seat of FIG. 1 with a child secured in the integral child seat;

FIG. 13 depicts a side elevational view of an exemplary alternative adjustment assembly that may be incorporated into the sub-assembly of FIG. 7;

FIG. 14 depicts a side elevational view of another exemplary alternative adjustment assembly that may be incorporated into the sub-assembly of FIG. 7; and

FIG. 15 depicts a side elevational view of another exemplary alternative adjustment assembly that may be incorporated into the sub-assembly of FIG. 7.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

The following examples are provided in the context of a seat (10) in a school bus. However, it should be understood that the below teachings may be readily applied in the context of numerous other kinds of vehicles. By way of the example only, the following teachings may be readily incorporated into a seat on a school bus, a public transportation bus, a charter bus, trucks of various sizes, a sedan or other type of automobile, a boat, an airplane, etc. Various other suitable contexts in which the following teachings may be applied will be apparent to those of ordinary skill in the art in view of the teachings herein. It should also be understood that seat (10) may be sized and configured such that it may be retrofitted as a replacement seat in a vehicle without having to alter other components of the vehicle. For instance, some versions of seat (10) may have dimensions comparable to the dimensions of a conventional bus seat, such that seat (10) may be used to replace a conventional bus seat without changing the spacing between the replaced seat and surrounding seats/structures (e.g., maintaining compliance with minimum knee spacing requirements, etc.). This may include seat (10) having a front-to-back thickness that is substantially uniform along the height of the upright seat back.

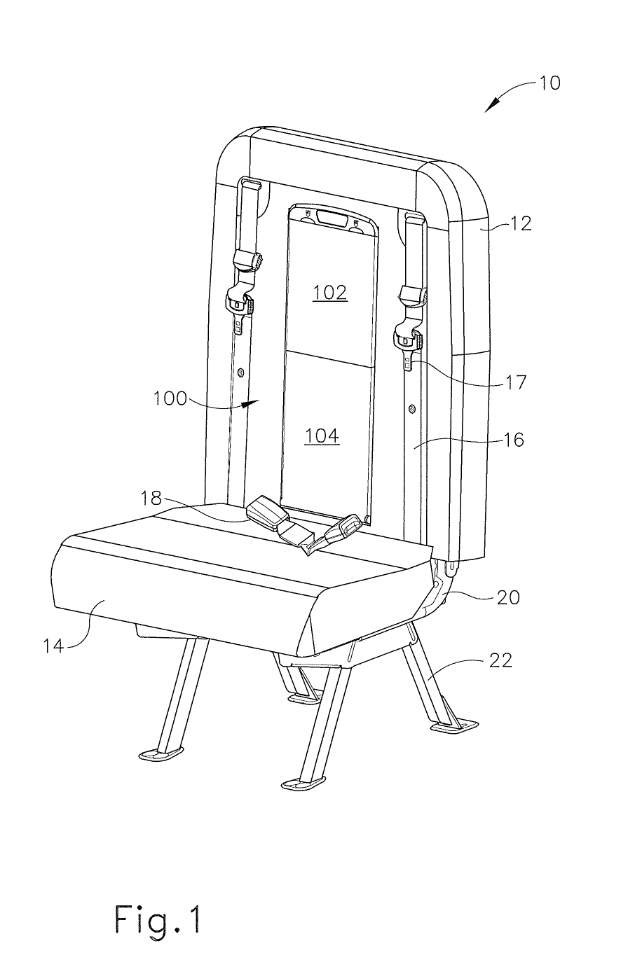

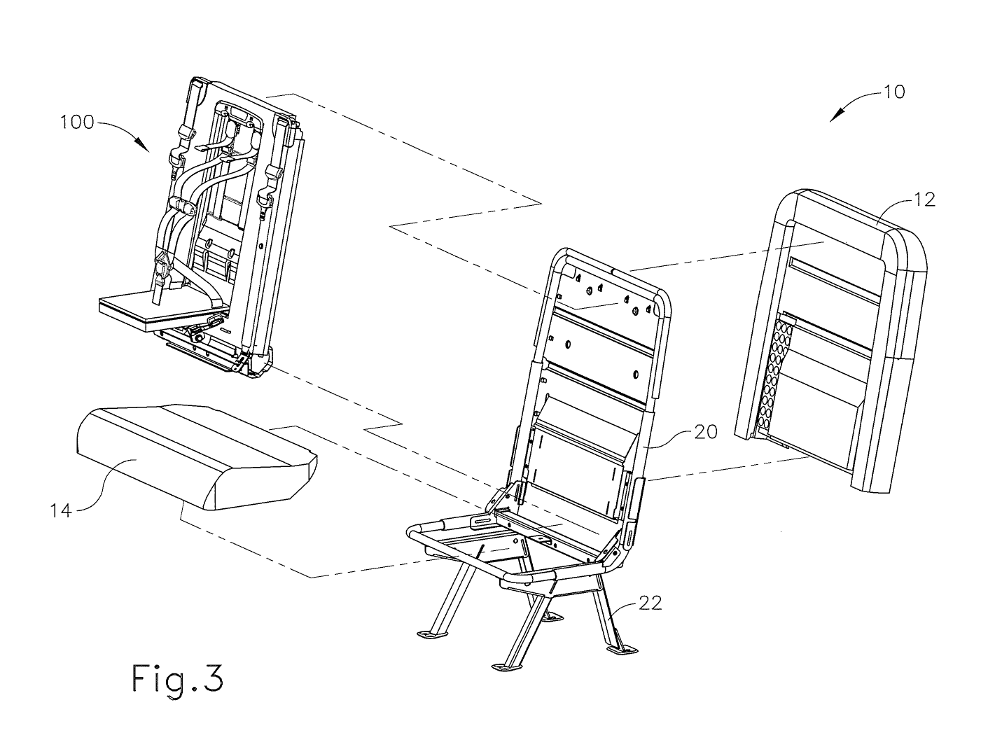

FIGS. 1-6 illustrate an exemplary bus seat (10) having an integral child seat assembly (100). While bus seat (10) is shown as having only one integral child seat assembly (100), it should be understood that bus seat (10) may alternatively have two or more integral child seat assemblies (100) (e.g., placed side-by-side, facing in the same direction, etc.). Bus seat (10) further comprises a frame (20) having four legs (22) that may be fixedly secured to the floor of a school bus, etc. In some versions, frame (20) comprises a conventional bus seat frame, though it should be understood that frame (20) may have any other suitable configuration. A cushioned seat back (12) and cushioned seat support (14) are secured to frame (20). Seat back (12) and seat support (14) may be sized such that bus seat (10) may fit passengers of various sizes, including adults. By way of example only, frame (20), seat back (12), and/or seat support (14) may be configured in accordance with at least some of the teachings of the one or more of the patent references cited herein. Other suitable configurations for these components will be apparent to those of ordinary skill in the art in view of the teachings herein.

Child seat assembly (100) is fixedly secured to frame (20) in a modular fashion. In other words, the relationship between child seat assembly (100) and frame in the present example enables ready selection and installation/replacement of different kinds of child seat assemblies (100) in frame (20) based on needs or preferences. Variations of child seat assembly (100) that may together form a pool of child seat assembly (100) types to choose from will be described in greater detail below; while still other variations will be apparent to those of ordinary skill in the art in view of the teachings herein. In some versions, child seat assembly (100) is secured to frame (20) with just two bolts. Various suitable ways in which child seat assembly (100) may be secured to frame (20) will be apparent to those of ordinary skill in the art in view of the teachings herein.

Child seat assembly (100) includes a pair of conventional seat belts (16), each having a sliding buckle tongue (17), and a pair of anchored buckles (18) that are configured to selectively engage tongues (17). Anchored buckles (18) may be configured similar to various kinds of conventional seat belt buckles. When coupled with buckle (18), seat belt (16) may fit horizontally over the lap of a passenger and diagonally across the torso of the passenger. Seat belt (16) may be formed of a conventional seat belt webbing material. In the present example, the lower end of seat belt (16) is fixedly anchored within child seat assembly (100); while the upper end of seat belt (16) is engaged with a conventional retractor (not shown) that is integrated into child seat assembly (100). Seat belts (16) and buckles (18) are configured to secure passengers of various sizes to bus seat (10), including children and adults. In some other versions, child seat assembly (100) has only one seat belt (16) and buckle (18). In still other versions, seat belt (16) and buckle (18) are omitted altogether.

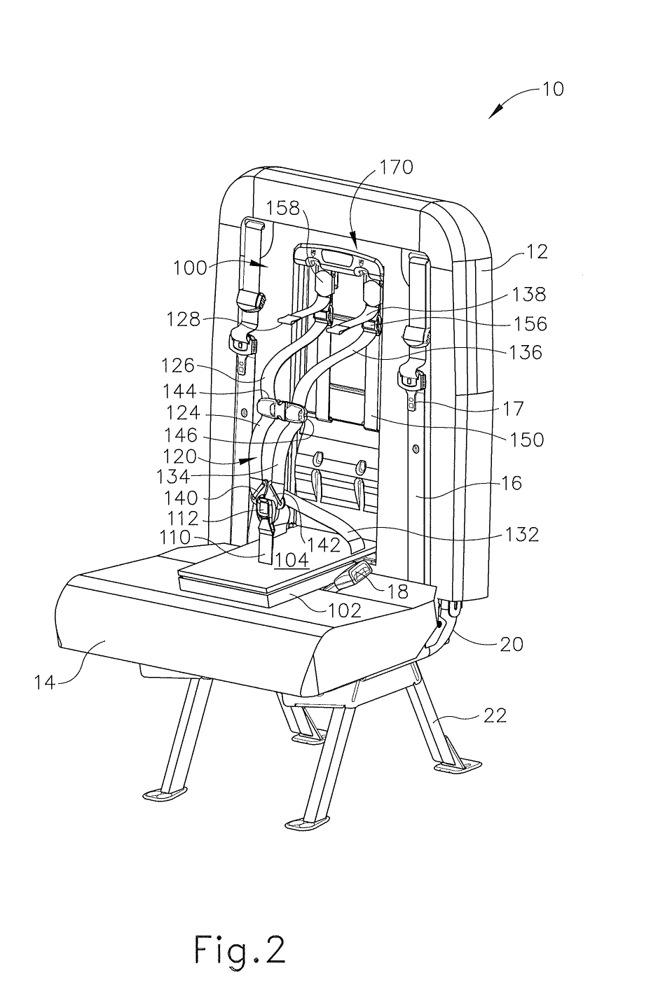

As best seen in FIGS. 1-2, child seat assembly (100) also includes a pair of panels (102, 104) that fold and unfold between an upright position (FIG. 1) and a folded position (FIG. 2). Panels (102, 104) of the present example are cushioned and are configured to occupy a recess of child seat assembly (100) when panels (102, 104) are in the upright position. In the present example, panel (102) has more cushioning and greater thickness the same amount of cushioning and/or thickness. Panels (102, 104) are maintained in the upright position when bus seat (10) is to be used by passengers who are large enough to be suitably secured by seat belt (16) and buckle (18). Panels (102, 104) thus cooperate with adjacent portions of child seat assembly (100) to present a substantially flat back rest for such passengers. Seat support (12) thus serves as a primary seat support when panels (102, 104) are in the upright position shown in FIG. 1. When it is desired to transport a smaller passenger (e.g., small child or toddler, etc.) in bus seat (10), panels (102, 104) may be readily folded to reveal additional restraints in child seat assembly (100) that are particularly configured for smaller passengers as will be described in greater detail below. In the folded configuration, panels (102, 104) together form a boosted seat for the smaller passenger. Panels (102, 104) thus form a secondary seat support.

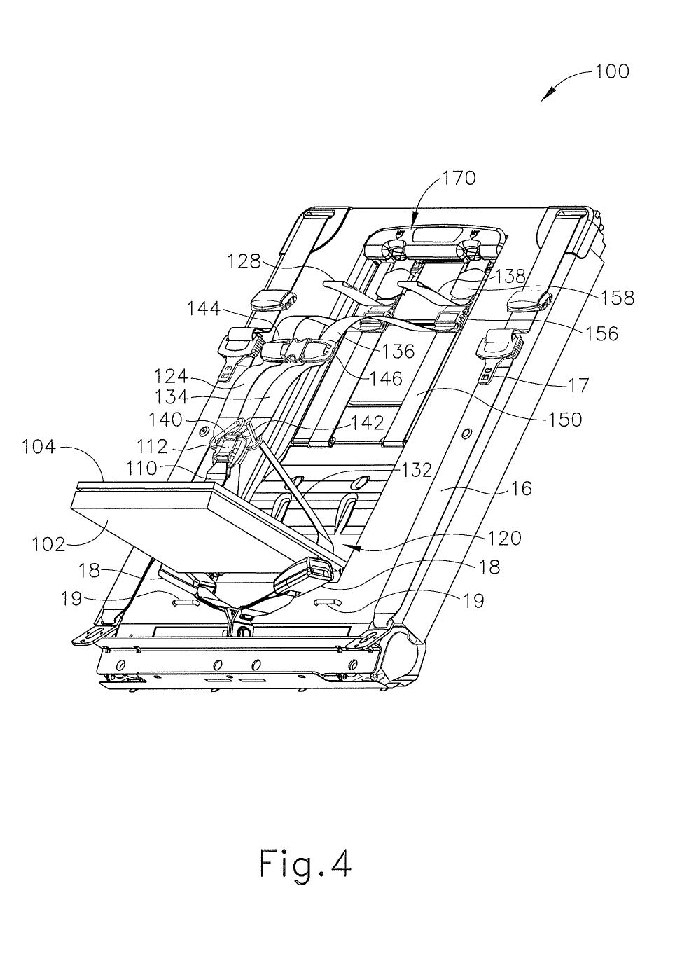

While the following features of child seat assembly (100) are described as being suitable for use in securing relatively small children to bus seat (10), there may be children (e.g., newborn infants, etc.) who are even too small to secure using the restraint features described below. Such children may need to be transported in a conventional removable child car seat. Such a child car seat may be secured to bus seat (10) using seat belt (16) and buckle (18) in accordance with instructions from the manufacturer of the car seat. Alternatively, some versions of child seat assembly (100) may include LATCH (Lower Anchors and Tethers for Children) anchors (19) as best seen in FIG. 4. Such anchors (19) may be configured like any other conventional LATCH anchors and may enable a child car seat to be clipped on to bus seat (10) via anchors (19) in accordance with a conventional LATCH system and in accordance with instructions from the manufacturer of the car seat. Of course, anchors (19) are merely optional and may be omitted if desired.

As shown in FIGS. 2-6, child seat assembly (100) comprises a crotch belt (110) with a dual-slot buckle (112). Crotch belt (110) is formed of a conventional seat belt webbing material and passes through three slots (182, 184, 186) that are formed in a base plate (180) that is embedded within panel (104). An anchor (not shown) secures crotch belt (110) underneath slot (186). Crotch belt (110) is thus held firmly to base plate (180) and has a non-adjustable length. Buckle (112) has two slots that are configured to releasably receive tongues (141, 143) as will be described in greater detail below. Buckle (112) may comprise a conventional two-slot child seat buckle, may be configured in accordance with the teachings of one or more of the patent references cited herein, or may have any other suitable configuration.

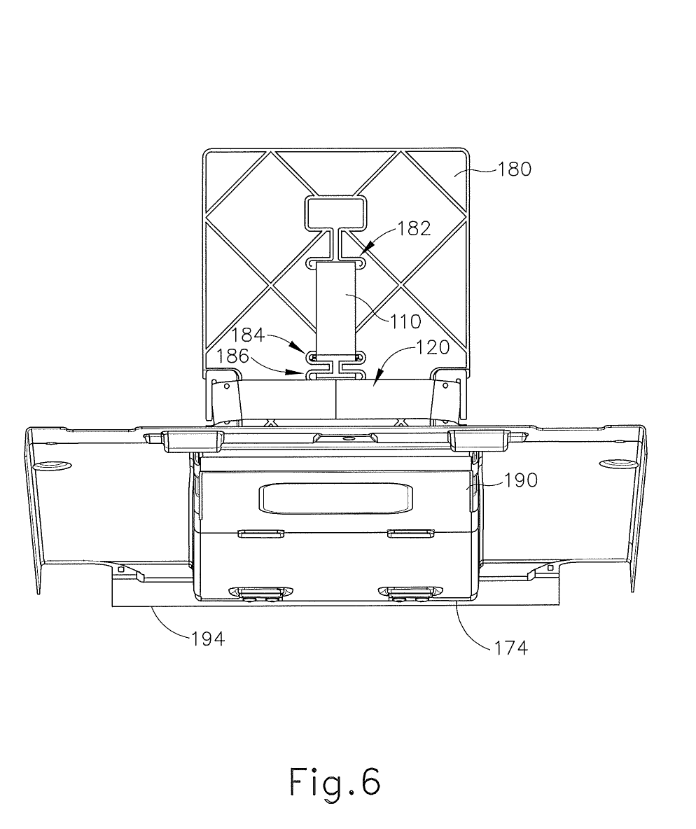

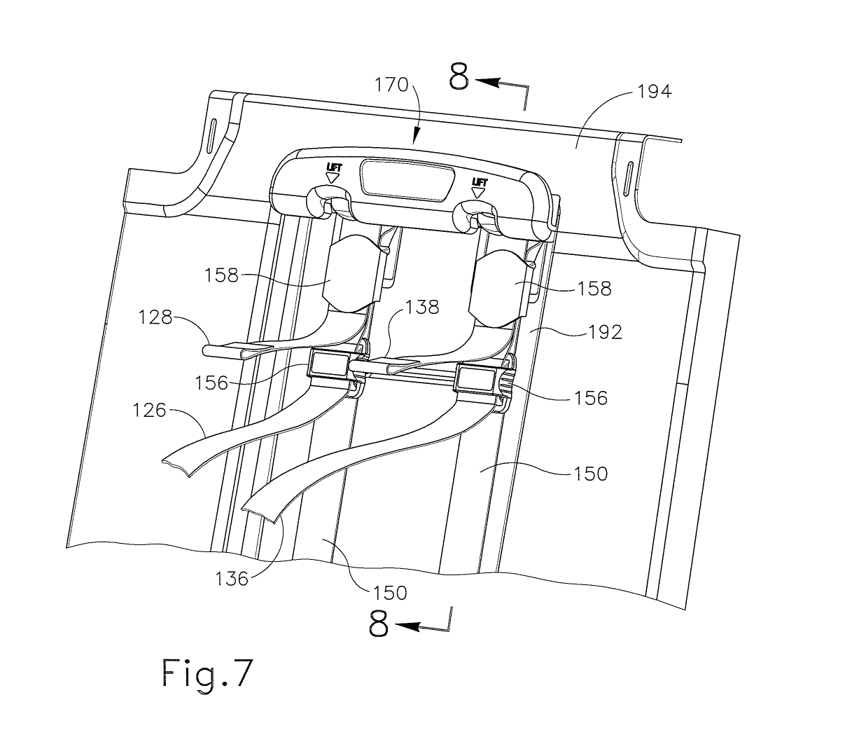

As shown in FIGS. 2-9, child seat assembly (100) further comprises a harness (120) that is configured to cooperate with crotch belt (110) to secure a small child to bus seat (10). Harness (120) comprises a single strip of conventional seat belt webbing material that passes under base plate (180) (see FIG. 6) and terminates in free ends (128, 138). In some versions, harness (120) is sewn to, clipped to, or otherwise secured to crotch belt (110) under base plate (180), to substantially prevent lateral movement of harness (120) under base plate (180).

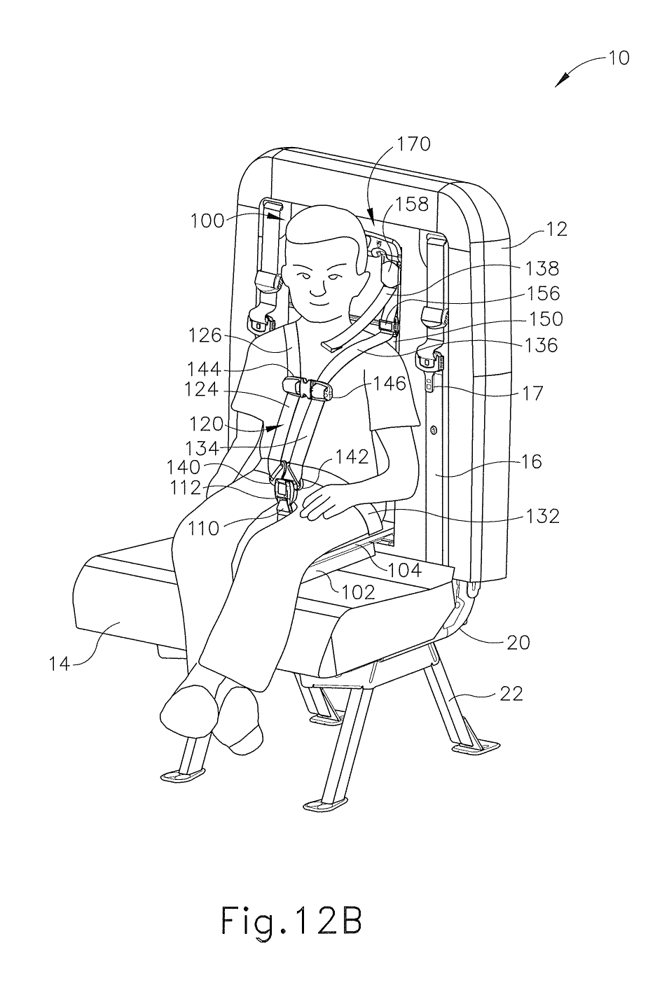

Harness (120) includes a right tongue slider (140) and a left tongue slider (140), as well as a right sternum latch member (144) and a left sternum latch member (146). Harness (120) forms a right lap belt portion (122) between base (180) and right tongue slider (140); and a left lap belt portion (132) between base (180) and left tongue slider (146). Harness (120) also forms a right torso belt portion (124) between right tongue slider (140) and right sternum latch member (144); and a left torso belt portion (134) between left tongue slider (142) and left sternum latch member (146). In addition, harness (120) forms a right shoulder belt portion (126) between right sternum latch member (144) and a right upper slider (156); and a left shoulder belt portion (136) between left sternum latch member (146) and a left upper slider (156). As shown in FIG. 12B and as will be described in greater detail below, when a passenger is seated in bus seat (10), tongues (141, 143) of tongue sliders (140, 142) are secured to buckle (112), and sternum latch members (142, 144) are secured together, lap belt portions (122, 132) fit over the passenger's lap, torso belt portions (124, 134) fit over the passenger's torso, and shoulder belt portions (126, 136) fit over the passenger's shoulders. Tongue sliders (140, 142), sternum latch members (142, 144), and upper sliders (156) may be slid along the webbing of harness (120) in order to suitably position these components as will be described in greater detail below.

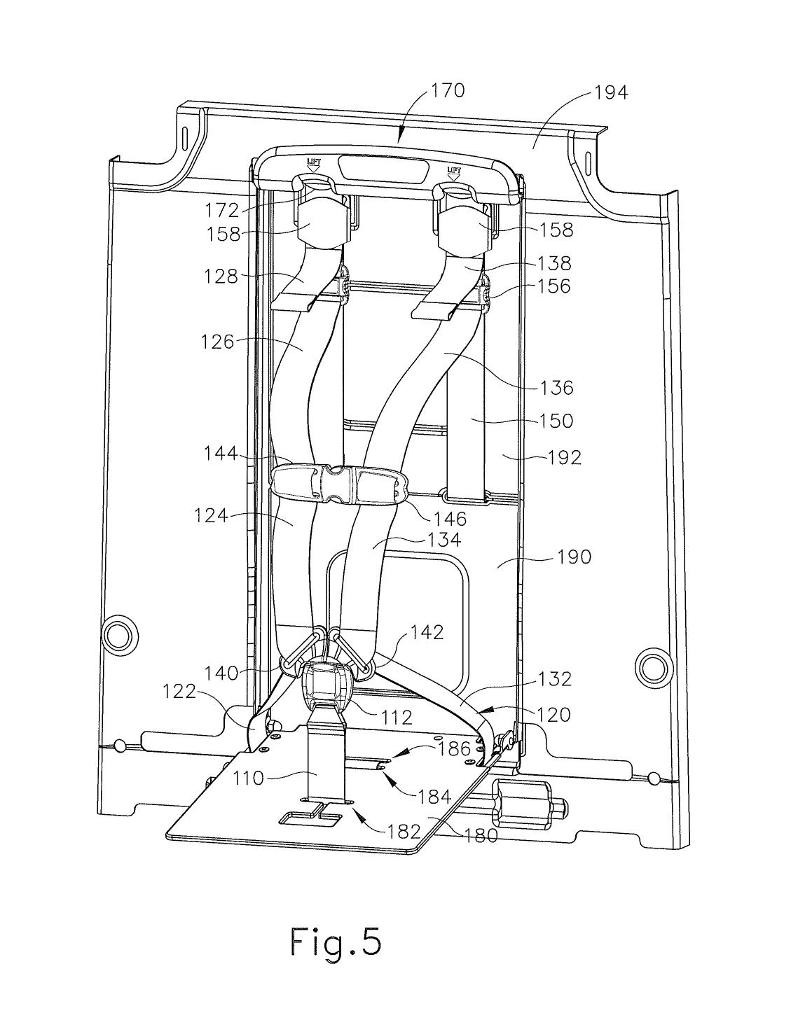

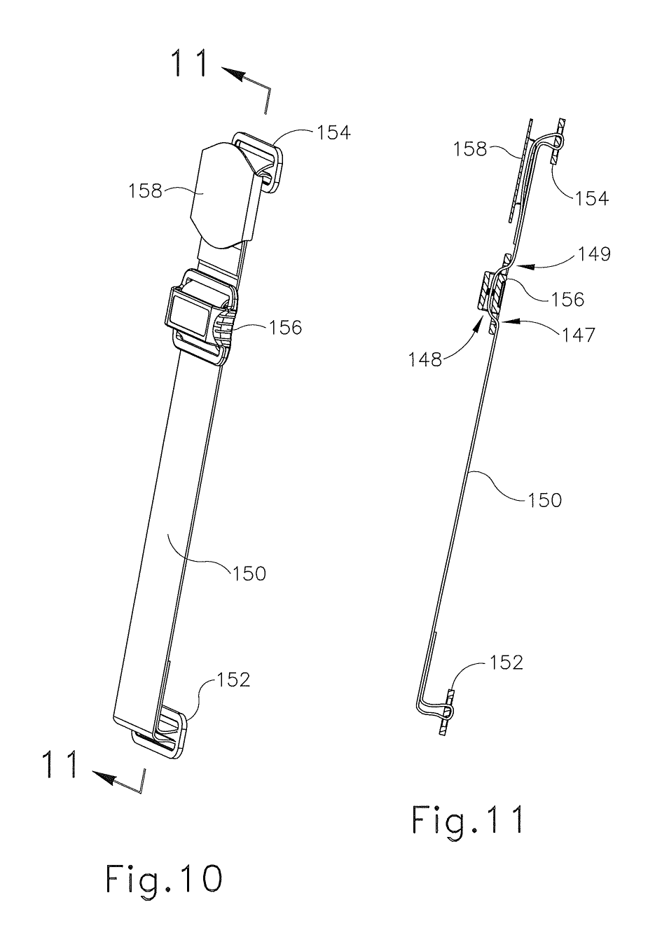

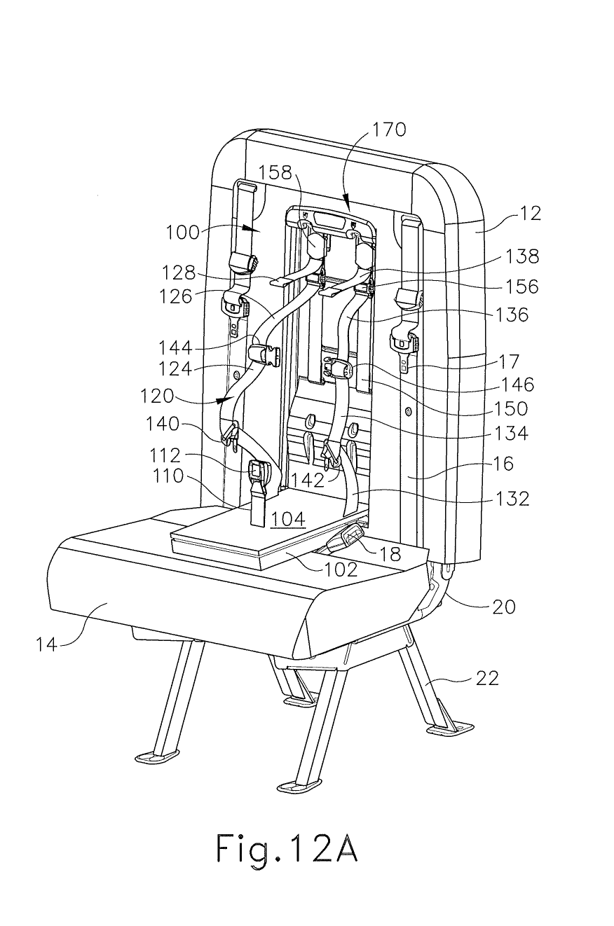

As best seen in FIGS. 5 and 7-8, harness (120) is secured to base webbing (150) via upper sliders (156). While base webbing (150) will be described in the singular below, it should be understood that both base webbings (150) are configured identically in the present example. Base webbing (150) is formed of a conventional seat belt material. As best seen in FIGS. 10-11, base webbing (150) includes a lower anchor member (152), an upper anchor member (154), and a guard member (158). The lower free end of base webbing (150) is passed through parallel slots formed in lower anchor member (152) and is then sewn to an adjacent region of base webbing (150), thereby securing base webbing (150) to a central cross-bar of lower anchor member (152). Lower anchor member (152) is positioned behind back plate (194), thereby preventing the lower end of base webbing (150) from being pulled free from back plate (194). Back plate (194) is embedded within child seat assembly (100), with removable, flexible pads (190, 192) being positioned between back plate (194) and the passenger.

The upper free end of base webbing (150) is passed through parallel slots formed in upper anchor member (154), then through a passage formed through guard member (158), and is then sewn to an adjacent region of base webbing (150), thereby securing base webbing (150) to a central cross-bar of upper anchor member (154) and to a rear portion of guard member (158). Upper anchor member (154) is positioned behind back plate (194), thereby preventing the upper end of base webbing (150) from being pulled free from back plate (194). Thus, anchor members (152, 154) together cooperate with back plate (194) to secure base webbing (150) within child seat assembly (100). Various other suitable ways in which base webbing (150) may be secured within child seat assembly (100) will be apparent to those of ordinary skill in the art in view of the teachings herein. In the present example, anchor members (152, 154) are spaced to hold base webbing (150) with a generally taut tension, yet with enough slack to permit upper slider (156) to slide along base webbing (150).

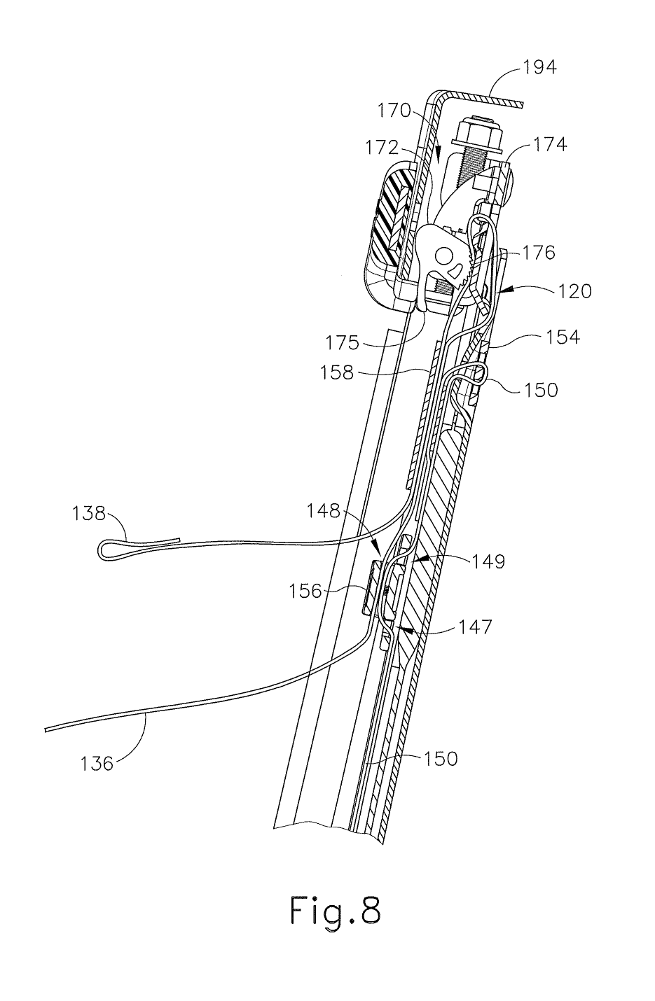

Base webbing (150) passes through three slots (147, 148, 149) formed in upper slider (156), with two of the slots (147, 149) being oriented along generally horizontal planes and the other slot (148) being oriented along a generally vertical plane. As best seen in FIG. 8, harness (120) also passes through slot (148) and is positioned adjacent to base webbing (150) within slot (148). Slot (148) is configured to permit upper slider (156) to slide along harness (120) and base webbing (150). It should be understood that upper slider and sternum latch members (144, 146) may be slid along harness (120) to vary the effective length of shoulder belt portions (126, 136), as will be described in greater detail below.

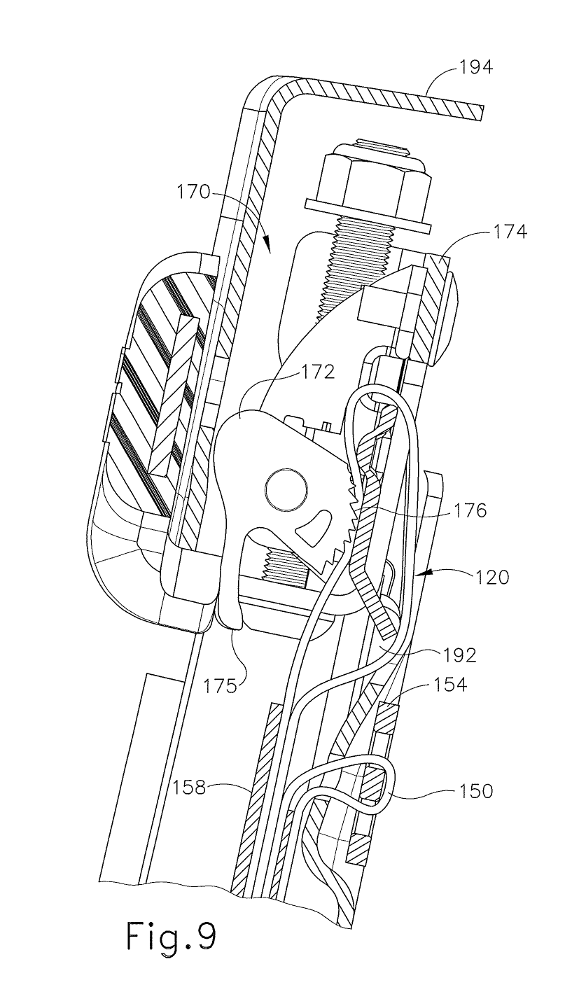

Harness (120) also passes through guard members (158) and then through adjustment assembly (170) before terminating in free ends (128, 138). As best seen in FIGS. 8-9, adjustment assembly (170) of the present example comprises a frame (174) that is securably fixed within child seat assembly (100). A pawl member (172) is pivotably secured within frame (174). Pawl member (172) includes a lever (175) and a set of teeth (176). Harness (120) passes behind the back side of frame (174), then through a slot formed in frame (172), then through a space between teeth (176) and frame (172) before exiting the bottom of adjustment assembly (170). Pawl member (172) is resiliently biased to urge teeth (176) against harness (120), to thereby capture harness (120) between teeth (176) and frame (174). For instance, adjustment assembly (170) may include a torsion spring, leaf spring, and/or some other type of resilient member to provide such bias to pawl member (172). Teeth (176) are configured to permit substantially free sliding of harness (120) downwardly relative to pawl member (172) (e.g., when a user pulls on free end (138)), even when teeth (176) are bearing against harness (120). However, teeth (176) are configured to prevent harness (120) from being pulled upwardly relative to pawl member (172) (e.g., such as by pulling downwardly on shoulder belt portions (136, 146)) when teeth (176) are bearing against harness (120). Teeth (176) may be disengaged from harness (120) by a user lifting up on lever (175) to pivot pawl member (172) (e.g., in the clockwise direction in the views shown in FIGS. 8-9)).

Frame (174) includes recesses that provide ready access to levers (175) from the front side of frame (174). In some versions, frame (174) is padded with foam or some other material, though this is merely optional. It should be understood that the above-described configuration of adjustment assembly (170) may provide relatively easy adjustment of harness (120) with a relatively low amount of frictional resistance during adjustment. Furthermore, positioning adjustment assembly (170) at or above the shoulder level instead of some other location (e.g., at the bight of the seat (10), where the seat back joins the bottom seat support) may help minimize the overall thickness of the seat back. It should also be understood that one or more components of adjustment assembly (170) may be configured in accordance with at least some of the teachings of U.S. Pat. No. 4,660,889, entitled “Harness Web Adjuster with Child Restraint Seat,” issued Apr. 28, 1987, the disclosure of which is incorporated by reference herein; and/or in accordance with the teachings of various other patent references cited herein. Various other suitable ways in which adjustment assembly (170) may be configured and operable will be apparent to those of ordinary skill in the art in view of the teachings herein.

As noted above, each base webbing (150) passes through a passage in a respective guard member (158) and is secured to the respective guard member (158). As shown in FIGS. 8-9, harness (120) also passes through the passages of guard members (158) and is positioned adjacent to base webbing (150) within the passage of guard member (158). In particular, harness (120) passes through the passage of guard member (158) a first time on its way up to adjustment assembly (170); then passes through the passage of guard member (158) a second time after passing through adjustment assembly (170). Free ends (128, 138) of harness (120) thus extend from respective guard members (158). In the present example, the position of guard members (158) along base webbings (150) is substantially fixed, while harness (120) may freely slide relative to guard members (158).

Guard members (158) of the present example are configured to substantially prevent a passenger's hair or clothing (or a user's hair or clothing) from getting caught in adjustment assembly (170) during adjustment of harness (120). For instance, when a passenger is being released from harness (120) as will be described in greater detail below, a user may lift up on lever (175) to disengage teeth (176) from harness (120) and may then pull on shoulder belt portions (126, 136) to create slack in harness (120). This causes free ends (128, 138) to travel upwardly toward adjustment assembly (170). When the passenger or user (e.g., an adult releasing a child from bus seat (10)) has long hair or clothing that may be captured in adjustment assembly (170), static and/or a structural feature of free end (128, 138) may catch the hair or clothing on free end (128, 138), which may in turn cause the hair or clothing to be pulled upwardly toward adjustment assembly (170). In the present example, the hair or clothing would reach guard member (158) before reaching adjustment assembly (170), and guard member (158) may sweep the hair or clothing away from free end (128, 138) before the hair or clothing can reach adjustment assembly (170). This sweeping action may be provided by the fit between harness (120), base webbing (150), and guard member (158); by the curved shape of the lower edge of guard member (158); and/or otherwise.

In the present example, free ends (128, 138) of harness (120) each include an integral sewn loop that provides increased thickness. This increased thickness substantially reduces the likelihood of free ends (128, 138) being completely pulled through guard members (158) (e.g., when a user pulls shoulder belt portions (136, 146) while holding levers (175) up). Alternatively, free ends (128, 138) may have any other suitable configurations, features, or properties. Similarly, other suitable configurations and positions for guard member (158) will be apparent to those of ordinary skill in the art in view of the teachings herein.

FIGS. 12A-12B depict steps in a process of securing a small child in bus seat (10). As shown in FIG. 12A, tongues (141, 143) are disengaged from buckle (112) and sternum latch members (144, 146) are disengaged from each other. Upper sliders (156) are slid to upper positions. The user may then lift lever (175) at the right side of adjustment assembly (170) and pull on right shoulder belt portion (126), which will draw free end (128) toward guard member (158) and provide additional length in harness (120) between upper slider (156) and panel (104) on that side of bus seat (10). Similarly, the user may lift lever (175) at the left side of adjustment assembly (170) and pull on left shoulder belt portion (136), which will draw free end (138) toward guard member (158) and provide additional length in harness (120) between upper slider (156) and panel (104) on that side of bus seat (10). Child seat assembly (100) is now configured to receive a child.

At this stage, a child may be sat on panel (104), with the child straddling crotch belt (110). The child's right arm may be passed through harness (120) between right shoulder belt portion (126) and right lap belt portion (122). Then the child's left arm may be passed through harness (120) between left shoulder belt portion (136) and left lap belt portion (132). Next, tongues (141, 143) may be inserted in buckle (112) and be secured therein. Sternum latch members (144, 146) may then be snapped together. The user may then pull on each free end (128, 138) to tighten harness (120) against the child. The user may then slide sliders (156) downwardly until they are positioned at about the same height as the child's shoulders. The user may also slide sternum latch members (144, 146) until the upper edge defined by the sternum latch members (144, 146) is at approximately the same height as the child's armpits. It should be understood that the user may make an initial adjustment of harness (120) tension by pulling on free ends (128, 138), then adjust the positions of sliders (156) and sternum latch members (144, 146), then make a subsequent adjustment of harness (120) tension by pulling on free ends (128, 138) again, and repeating this process until a desired positioning and tension are achieved. In some instances, harness (120) may be tightened just to a point where it is difficult for the user to pinch more than an inch of the webbing of harness near the child's shoulder; or to the point where the user is able to just fit a finger between harness (120) and the child's shoulder. FIG. 12B shows an example of a child secured in child seat assembly (100). Other suitable fastening and adjustment techniques that may be carried out through child seat assembly (100) will be apparent to those of ordinary skill in the art in view of the teachings herein.

To remove a child from child seat assembly (100), the user may first lift levers (175) and pull on shoulder belt portions (128, 136) to create slack and length in the region of harness (120) between guard members (158) and panel (104). This will draw free ends (128, 138) toward corresponding guard members (158). To the extent that the user's hair/clothing and/or the passenger's hair/clothing is pulled with free ends (128, 138), guard members (158) will effectively wipe the hair/clothing away and prevent the hair/clothing from entering adjustment assembly (170). The user may then decouple sternum latch members (144, 146) from each other and disengage tongues (141, 143) from buckle (112). The child may then be removed from or otherwise freely exit child seat assembly (100). If desired, panels (102, 104) may then be unfolded and pivoted to the generally upright position shown in FIG. 1. Panels (102, 104) may then stay in that position due to friction, a latch feature, using hook and loop tape, or using any other suitable components, features, or techniques. In some instances, after a child is no longer seated in child seat assembly (100), the user may again pull free ends (128, 138) to remove at least some of the slack in the region of harness (120) between guard members (158) and panel (104) before unfolding and pivoting panels (102, 104) to the generally upright position shown in FIG. 1.

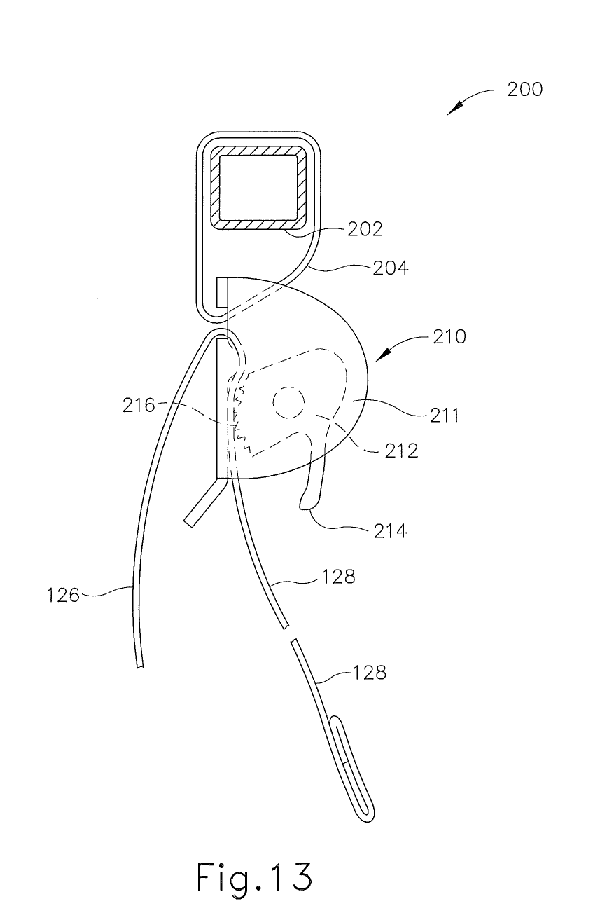

It is contemplated that various components described above may be modified in numerous ways. For instance, FIGS. 13-15 show exemplary modified forms that may be taken by adjustment assembly (170). It should be understood that the following examples may be readily incorporated into child seat assembly (100) with complementary components as described above. FIG. 13 shows an adjustment assembly (200) where a transverse bar (202) is used instead of frame (174). A closed web loop (204), formed of conventional seat belt webbing material, encompasses transverse bar (202). An adjuster (210) hangs from web loop (204). Adjuster (210) includes a housing (211) and a pawl member (212) that is configured just like pawl member (172) described above. In some versions, adjuster (210) is configured in accordance with at least some of the teachings of U.S. Pat. No. 4,660,889, the disclosure of which is incorporated by reference herein. A shoulder belt portion (126) is fed through the back of housing (211), passes between teeth (216) of pawl member (212) and an inner surface of housing (211), then exits at the bottom of housing (211). Pawl member (212) permits a user to freely pull free end (128) to tighten harness (120); but requires the user to lift lever (214) in order to disengage harness (120) from teeth (216) for loosening harness (120).

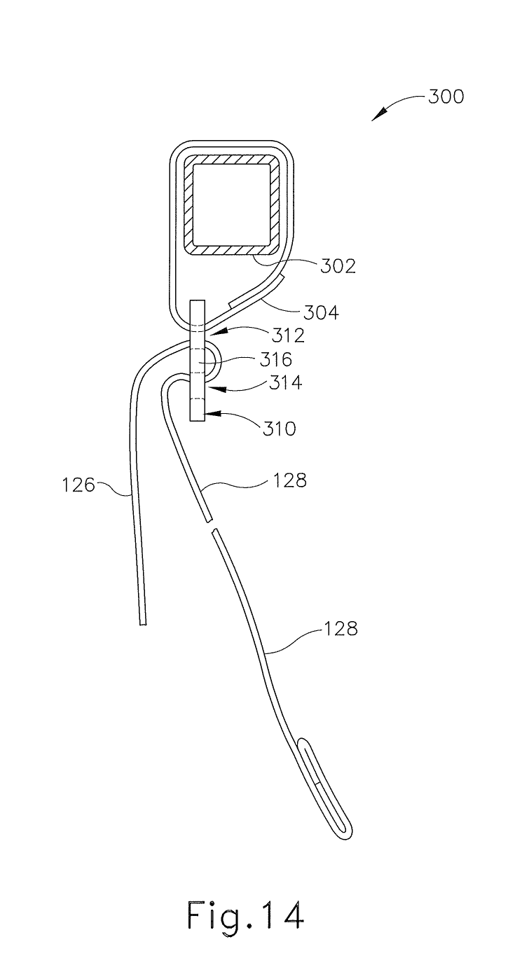

FIG. 14 shows an adjustment assembly (300) that also includes a transverse bar (302) instead of a frame (174). A closed web loop (304), formed of conventional seat belt webbing material, encompasses transverse bar (302). An adjuster (310) hangs from web loop (304). Adjuster (310) of this example is a rectangular metal member defining two parallel slots (312, 314). A shoulder belt portion (126) is fed through the back of adjuster (310) via slot (312), passes over a bar (316) separating slots (312, 314), then is fed back through slot (314) and exits from the rear of adjuster (310). Adjuster (310) is configured to substantially prevent harness (120) from sliding through adjuster (310) when adjuster is in the position shown in FIG. 14. However, adjuster (310) permits harness (120) to slide through adjuster (310) when a user engages the bottom of adjuster (310) and pivots it upwardly by approximately 45° to approximately 90°. Such pivoting of adjuster (310) may be required regardless of whether the user is attempting to tighten or loosen harness (120). Some variations of this example may include three or more slots instead of just two slots (312, 314).

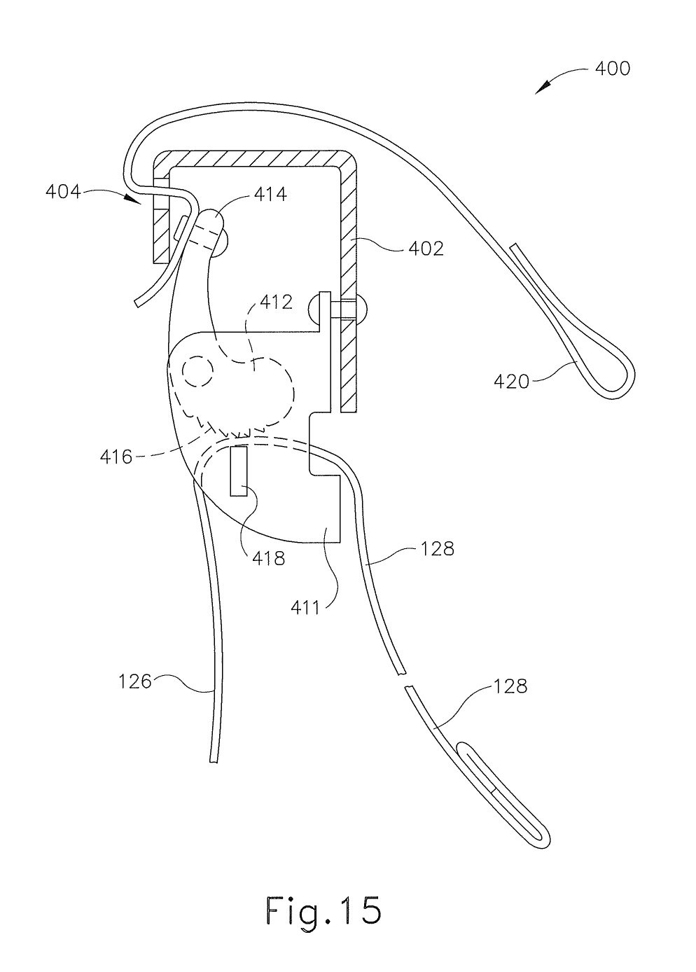

FIG. 15 shows an adjustment assembly (400) that includes a frame (402) and an adjuster (410) fixedly secured to frame (402). Adjuster (410) includes a housing (411) and a pawl member (412) that is configured just like pawl member (172) described above. In some versions, adjuster (410) is configured in accordance with at least some of the teachings of U.S. Pat. No. 4,660,889, the disclosure of which is incorporated by reference herein. In the present example, a bearing beam (418) is secured to housing (418) near teeth (416) of pawl member (142). A shoulder belt portion (126) is fed through the bottom of housing (411), crosses over bearing beam (418), then exits adjuster (410) through a slot formed in the front of housing (411). Pawl member (412) permits a user to freely pull free end (128) to tighten harness (120); but requires the user to actuate lever (414) in order to disengage harness (120) from teeth (416) for loosening harness (120). In the present example, a release strap (420) is secured to lever (414), passes through a slot (404) formed in the rear of frame (402), then drapes over the front of frame (402). Release strap (420) is configured to rotate pawl member (412), to thereby release harness (120) from teeth (416), in response to the user pulling on release strap (420).

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

I/we claim:

1. A vehicle seat comprising:
(a) a frame;
(b) a primary seat support secured to the frame;
(c) a seat back secured to the frame; and
(d) a child seat assembly secured to the frame adjacent to the seat back, wherein the child seat assembly comprises,
(i) at least one panel pivotable relative to the frame,
(ii) a harness configured to removably secure an occupant of the child seat assembly relative to the frame, and
(iii) an adjustment assembly configured to provide adjustment of the harness, wherein the adjustment assembly comprises a pivoting member operable to selectively restrain movement of at least a portion of the harness.

2. The vehicle seat of claim 1, wherein the at least one panel comprises a pair of panels.

3. The vehicle seat of claim 2, wherein the panels in the pair are foldable relative to each other.

4. The vehicle seat of claim 1, wherein the at least one panel is configured to move between an upper position and a lower position, wherein the at least one panel is configured to cover the harness when the at least one panel is in the upper position, wherein the at least one panel is configured to reveal the harness when the at least one panel is in the lower position.

5. The vehicle seat of claim 4, wherein the at least one panel is further configured to provide a secondary seat support for an occupant of the child seat assembly.

6. The vehicle seat of claim 1, wherein the harness comprises webbing configured to fit over the lap, torso, and shoulders of an occupant of the child seat assembly.

7. The vehicle seat of claim 6, the child seat assembly further comprising a crotch strap and a buckle, wherein the buckle is configured to releasably secure the harness with the crotch strap.

8. The vehicle seat of claim 6, wherein the webbing includes a pair of free ends movable relative to the adjustment assembly.

9. The vehicle seat of claim 1, wherein the pivoting member comprises a pawl with teeth, wherein the teeth are configured to selectively engage the harness to selectively restrain movement of at least a portion of the harness.

10. The vehicle seat of claim 9, wherein the adjustment assembly comprises a resilient member configured to bias the teeth into engagement with the harness.

11. The vehicle seat of claim 1, wherein the seat back and the child seat assembly together define a height and a front-to-back thickness, wherein the front-to-back thickness is substantially uniform along the height.

12. The vehicle seat of claim 1, wherein the child seat assembly further comprises at least one strip of base webbing, wherein the harness is slidably secured to the base webbing.

13. The vehicle seat of claim 12, wherein the child seat assembly further comprises a sliding member engaged with the at least one strip of base webbing and the harness.

14. The vehicle seat of claim 1, wherein the child seat assembly further comprises a guard member, wherein the guard member is configured to deflect hair and clothing away from the adjustment assembly during sliding movement of the harness relative to the adjustment assembly.

15. The vehicle seat of claim 14, wherein the child seat assembly further comprises at least one strip of base webbing, wherein the harness and the base webbing are both engaged with the guard member.

16. A vehicle seat comprising:
(a) a frame; and
(b) a child seat assembly secured to the frame, wherein the child seat assembly comprises,
(i) a harness configured to removably secure an occupant of the child seat assembly relative to the frame,
(ii) an adjustment assembly configured to provide adjustment of the harness, wherein the harness is selectively slidable relative to the adjustment assembly, and
(iii) at least one guard member coupled with the harness, wherein the at least one guard member is configured to deflect hair and clothing away from the adjustment assembly during sliding movement of the harness relative to the adjustment assembly.

17. The vehicle seat of claim 16, wherein the child seat assembly further comprises at least one panel pivotable relative to the frame.

18. The vehicle seat of claim 16, wherein the adjustment assembly comprises a pivoting member operable to selectively restrain movement of at least a portion of the harness.

19. A vehicle seat comprising:
(a) a frame; and
(b) a child seat assembly secured to the frame, wherein the child seat assembly comprises,
(i) a harness configured to removably secure an occupant of the child seat assembly relative to the frame, wherein the harness includes a lap portion configured to fit over the lap of an occupant of the child seat assembly and a shoulder portion configured to fit over the shoulder of an occupant of the child seat assembly, and
(ii) an adjustment assembly configured to provide adjustment of the harness, wherein the adjustment assembly is positioned above the shoulder portion of the harness.

20. The vehicle seat of claim 19, further comprising:
(a) a primary seat support secured to the frame; and
(b) a seat back secured to the frame, wherein the child seat assembly is secured adjacent to the seat back.
